(19) United States
(12) Patent Application Publication
(10) Pub. No.: US 2012/0111892 A1
(43) Pub. Date: May 10, 2012

(54) Multiple beverage dispenser adapter

(76) Inventors: James Mitchell Leith, SR., Moody, AL (US); Trace Malone Leith, Hoover, AL (US)

(21) Appl. No.: 12/927,027

(22) Filed: Nov. 5, 2010

(51) Int. Cl. B67D 7/06

(52) U.S. Cl. 222/185.1

(57) ABSTRACT

A multiple option beverage dispenser, for gravitationally dispensing a liquid beverage from standard recyclable plastic bottle containers available commercially, having a standard screwed neck. The instant invention called “Multiple Beverage Dispenser Adapter” is a one piece device, preferably injection molded of preferred plastic construction for economy of production. The heart of the instant inventions' design comprises a multi-tiered female threaded plastic bottle receiver, a fluid chamber, and a tubular discharge end for liquid exit. The instant invention, designed as a companion equipment device, to be a clean and simple installation, into a wide variety of commercially produced host ice cooler/chests having dispensing spigots, or that spigots may be added (retro-fitted), providing a unique scope of utility, size, durability, and appearance.

### BACKGROUND OF THE INVENTION

1. Field of Invention

The technical field of invention relates to devices for the dispensing of bottled drinking beverages (liquids) having a receiving device to deplete liquid gravitationally from standard sized bottled drinking water. This instant invention comes within the field of manually dispensing a beverage from a commercially produce standard bottle container, with screwed neck, from within a commercially produced host thermal ice cooler/chest of a single beverage, having a dispensing spigot. More specifically, it relates to the ability of the instant invention, as a companion device installed within a spigot ice cooler/chest, or where a spigot may be added (retro-fitted), whereby a wide variety of beverages may be employed to dispense via the existing or add-on spigot.

2. Description of Prior Art

Among Outdoor & Sports Product users, Contractors, Industrial work crews, and other users of thermal ice cooler/chests having spigots, it is a universally accepted practice to introduce a single beverage (i.e. water and/or ice) into the cooler/chest and manually dispense the chilled media via the existing spigot into a hand held receiver (i.e. drink cup). In recent times, there have been patents issued for “Portable Bottled Water Dispenser” being a totally self-contained, stand alone process for extracting & disbursement of bottled water, which sets them apart from dispensing through a host ice cooler/chest. This utilization practice offers no advantage of introducing multiple choice of beverage, in addition to the (water) media inside the ice cooler/chests cavity. The improvement and usefulness of the instant invention, over the prior art, is to offer users of new and existing host ice cooler/chests the instant capability of providing a wide range of commercially available beverages of differing threaded neck sizes, while maintaining the chilled water media aspect.

### SUMMARY OF THE INVENTION

The instant invention was conceived to offer options to users of ice cooler/chests having spigots, providing an almost endless variety of beverage choice over the single beverage utility of said ice cooler/chests. The instant invention forms a genuine kit package companion device to said ice cooler/chests with spigots, whereby enabling choice of beverage. The instant invention is constructed of preferably non-conductive recyclable plastic, similar to that of commercially produced ice cooler/chests, and preferred injection molded into a single piece with no moving parts, for economy of manufacture. The heart of the instant invention design consists of a unique multiple tiered female threaded bottle receiver to accept an *assortment of different size standard threaded neck recyclable plastic bottles or jugs commercially produced of available popular beverages. The instant invention was perceived and designed to be installed into the interior bottom of said host ice cooler/chest at the proper relationship to the existing ice cooler/chest's spigot for mounting thereto. After final installation, the existing ice cooler/chest spigot may be disassembled and removed, or replaced by a new spigot, without disturbing the presents of the instant invention. *Accommodation of bottle sizes with screwed necks: (1) standard 2 liter, (2) standard ½ or 1 gallon, & (3) standard 64 ounce.

The use of the instant invention is to simply remove bottle cap from beverage bottle, invert the cooler/chest containing the instant invention, and insert (screw) bottle into the appropriate size threaded receiver tier and secure tightly, set ice cooler/chest back upright. A small hole must be administered to the bottom end of bottle for venting. Manually activate the existing host ice cooler/chest spigot and beverage will deplete normally by natural liquid gravity until existing spigot is deactivated for quantity desired. Upon depletion of selected beverage, repeat the loading process with another Beverage of choice, as many times as required. Replace coolant media as necessary.

### BRIEF DESCRIPTION OF DRAWINGS

Drawing 1/1 shows three (3) basic external views. Plan FIG. 1, Side FIG. 2, and Front FIG. 3.

FIG. 4 shows a longitudinal “Section” and

FIG. 5 shows the discharge end.

All objects are depicted in orthographic planes with minimal control dimensions to indicated scope (size) of instant invention. An un-named drawing sketch is included, as my interpretation of request for a picture, or representation of intended use as the “Front Page View”, at your discretion. The drawings are prepared per U.S. Patent specifications. Size 8½″×11″ as per 37 CFR 184(f) and margins as per 37 CFR 1.84(g).

### DESCRIPTION OF THE PREFERRED EMBODIMENT

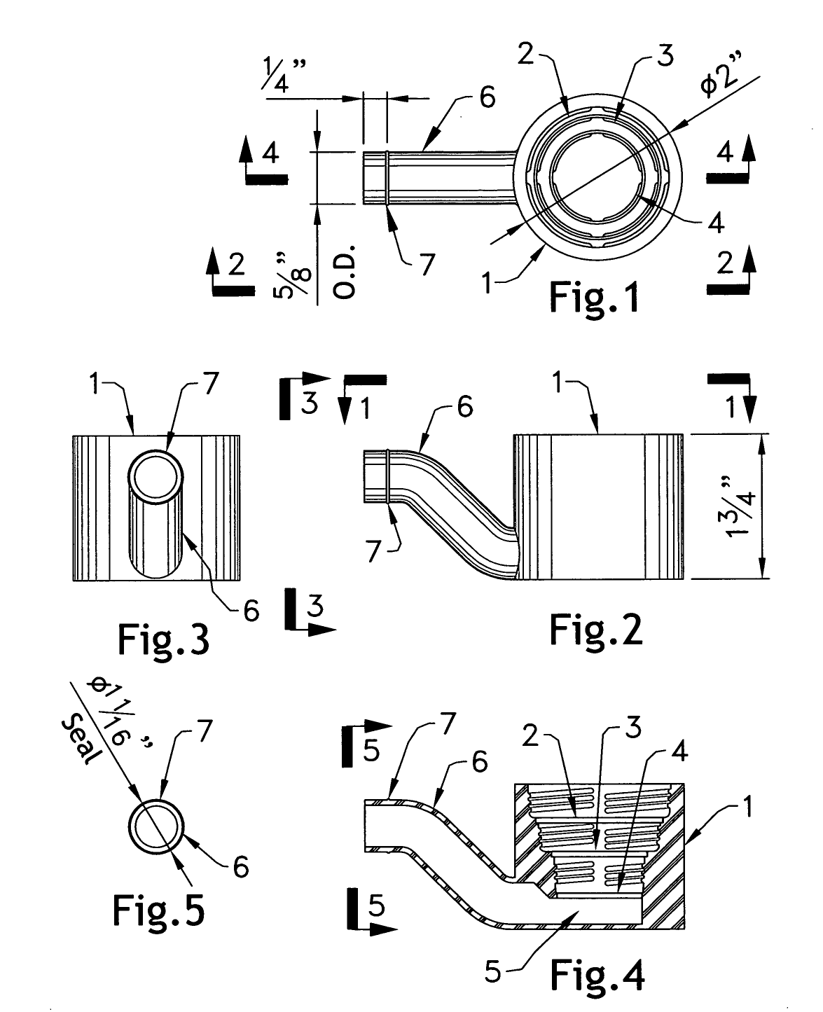

In reference to the accompanying drawing sheet 1/1, the intended invention called “Multiple Beverage Dispenser Adapter” comprises a cylindrical main body 1, as indicated in FIGS. 1, 2, & 3. As shown in FIG. 1 & FIG. 4, the multiple tiers of standard female threaded bottle receivers are indicated as upper tier for 64 oz. threaded plastic containers 2, intermediate tier for ½ and 1 gallon threaded plastic containers 3, and the lower tier for 2 liter threaded plastic containers 4. Also shown, in FIGS. 1, 2, 3, 4, & 5, is the discharge tube 6, and discharge tube seal 7. The fluid channel 5 is shown in FIGS. 1 & 4. All control dimensions are given only to indicate scope and size of the intended unit.

It is to be noted, that all items numbered 1 through 7, are monolithically and integrally preferred molded into a single comprehensive unit device of preferred plastic, similar to that of commercially produced thermal ice cooler/chests.

It is to be further noted, that this said “one piece unit device” is designed to be installed into a new or existing “host” ice cooler/chest, having existing or add-on dispensing spigots.

It is also noted, that this said unit device's discharge tube portion is to be inserted into the existing said ice cooler/chest's spigot from the inside of said host ice cooler/chest, with a hand push-on of no more than ⅜ inch bottom of the said “host” cooler/chest with a recommended water resistant glue strip similar to “Uglu”.

It is also further noted, that the said “host” ice cooler/chest's spigot may be dismantled (disassembled), or removed (replaced), without disturbing the presence of the said Multiple Beverage Dispenser Adapter unit resident inside said host ice cooler/chest.

It is also further noted, that the said intended invention “Multiple Beverage Dispenser Adapter” unit, may also be retrieved form said “host” ice cooler/chests and replaced by a new one.

The invention claimed is:

1. A one piece beverage dispenser adapter for gravitationally dispensing liquid beverage from standard thread neck bottles, the dispenser comprising: a main body portion having an internal multi-tiered standard female threaded receiver, and internal fluid channel, and hollow cylindrical discharge portion integrally formed with said body.

2. The beverage dispenser adapter, as in claim 1, wherein said adapter is to be made preferably of molded plastic.

3. The beverage dispenser adapter, as in claim 2, wherein said adapter having been Integrated/installed within a host ice cooler/chest with spigot, forms a configuration of a comprehensive multiple beverage dispensing system.
